(19) United States
(12) Patent Application Publication
(10) Pub. No.: US 2009/0289040 A1
(43) Pub. Date: Nov. 26, 2009

(54) Method and Device for Measuring Resistance Spot Welding Electrode Tips While Connected to a Robotic Welder

(76) Inventor: Scott Boyd, Union, OH (US)

Correspondence Address: R. William Graham, 22 S. St. Clair St., Dayton, OH, 45402, US

(21) Appl. No.: 12/124,343

(22) Filed: May 21, 2008

(51) Int. Cl. B23K 11/25; B23K 11/30

(52) U.S. Cl. 219/86.41; 219/110

(57) ABSTRACT

A method and device for measuring a resistance spot welding electrode tip includes a welding electrode tip monitoring device for monitoring a welding electrode tip, the welding electrode tip monitoring device communicatively connected to a robotic welder equipped with electrode welding tips in a manner to be automatically employed as part of a robotic step with the robotic welder and is equipped with a mechanism for generating characteristic data of the welding electrode tips without having to remove the welding tips from the robotic welder.

### FIELD OF THE INVENTION

The present invention relates to electrical resistance welding. More specifically, the invention relates to a device and method and device for measuring resistance spot welding electrode tips while connected to a robotic welder.

### BACKGROUND OF THE INVENTION

Resistance spot welding depends on the resistance of the base metal and the amount of current flowing to produce the heat necessary to make the spot weld. Typically, several thousands of amperes are used in making the spot weld. Such amperage values, flowing through a relatively high resistance, will create a lot of heat in a short time. To make good resistance spot welds, it is necessary to have close control of the time the current is flowing and time as the controllable variable since current is economically impractical to control in most single impulse resistance spot welding applications.

Proper pressures and intimate contact of the electrode tip and the base metal will tend to conduct heat away from the weld. Higher currents are necessary with greater pressures while lower pressures need less amperage from the resistance spot welding machine. The electrode tips are thus of critical importance as they conduct the welding current to the work piece, apply pressure to the weld joint, and conduct heat from the work surface. It is important to maintain the tips shape and characteristics of thermal and electrical conductivity to provide quality and consistent welds.

With this in mind, there is a need to monitor the performance and characteristics of the electrode tip's geometry in order to provide consistent spot welds. Previously, the tips would be routinely removed from their robotic machines and replaced after a predetermined number of welds. This is less desirable in that the performance of the tip may have either degraded prior to the predetermined number of uses or the tip may have been removed before necessary. Further, the amount of time necessary to perform replacement led to extra down time on the machine.

Some attempts to increase the life cycle of resistance spot welding tips have included modifying the contact resistance through mechanical and/or chemical means or increasing current to compensate for the increase in surface area of the electrode contact surface due to erosion. These enhancements are costly and do not solve the monitoring problem.

In sum, a robotic welder requires continuous monitoring of the critical features stated above to maintain weld quality. Prior methods include periodic manual inspections requiring a work cell employing the robotic welder to be shut down. Monitoring weld quality in resistance welding is a known problem and there has yet to provided a suitable method and device for use in monitoring such welding tips as part of the robotic machine process and while maintained ready for use. The present invention solves the aforementioned problem.

### SUMMARY OF THE INVENTION

It is a general object to improve resistance spot welding.

It is another object to maximize the effective utility of welding electrode tips.

It is an object to provide a device and method for measuring critical features of resistance welding electrode tips.

It is another object to provide a device and method for measuring such features of welding electrode tips while attached to a robotic welder.

It is another object to generate information through in-process inspection as to contact diameters, misalignment and force of welding electrode tips.

Accordingly, one aspect of the present invention is directed to a method of measuring a resistance spot welding electrode tip. The method includes the steps of operatively associating a welding electrode tip monitoring device for monitoring the welding electrode tip while connected to a robotic welder such that the device is automatically employed as part of a robotic step with the robotic welder. The welding electrode tip monitoring device generates characteristic data of the welding electrode tip during the operation of the robotic device. The method further includes using the characteristic data to determine the need for changing the welding electrode tip. The method further includes using the characteristic data to adjust an operation of the robotic welder to affect weld characteristics. The method contemplates employing a process controller to receive the characteristic data and perform such operations.

The method is further characterized such that the welding electrode tip monitoring device is automatically employed at predetermined intervals. For example, the robotic welder and welding electrode tip monitoring device can operate at predetermined cycles i.e. every 100, 200 or 500 welds, or whatever the process requires and communicate with the process controller to either re-dress or replace the tips as the generate characteristic data indicate.

The welding electrode tip monitoring device can include a tip geometry obtaining mechanism and tip force obtaining mechanism. The tip force obtaining mechanism can reside proximate the tip geometry obtaining mechanism to permit characteristic data to be readily obtained.

When the process controller instructs the robot welder to inspect the tips, the robotic welder will position the tip inside the tip geometry obtaining mechanism. The tip geometry obtaining mechanism can employ such means as a camera to obtain dimensional features of the tip(s). The robotic welder is then instructed to position the tips in relation to the force capturing mechanism, wherein the tips clamp on a load cell sensor to obtain force features of the tips after a predetermined time. For example after 5 seconds, the maximum force inspected is recorded.

The welding electrode tip monitoring device compares the data to tolerance threshold values and returns a signal to the process controller as to the condition of the tip features. The process controller can be programmed to return the robotic welder to welding, re-dress the tips, replace the tips or signal the mechanism requires maintenance.

Another aspect of the invention is directed to a device for measuring a resistance spot welding electrode tip. The device includes a welding electrode tip monitoring device for monitoring a welding electrode tip a while connected to a robotic welder, wherein the welding electrode tip monitoring device is automatically employed as part of a robotic step and is equipped with means for generating characteristic data of the welding electrode tip without having to remove the tip from the robotic welder. The device includes a process controller to receive the characteristic data and determine the need for changing the welding electrode tip and or adjust an operation of the robotic welder to affect weld characteristics. The welding electrode tip monitoring device can preferably include a mechanism for obtaining tip geometry and a mechanism for obtaining tip force.

The welding electrode tip monitoring device can preferably automatically measure dimensions of resistance weld tips, upper tip minimum contact diameter, lower tip minimum contact diameter, and center line misalignment of upper and lower tips. The welding electrode tip monitoring device can preferably automatically measure robotic clamp force.

The welding electrode tip monitoring device can preferably include a CCD camera with lens and back light and a load cell sensor. The welding electrode tip monitoring device can be operatively associated the robotic welder. The process controller can preferably have a user defined tolerance threshold software associated therewith to specify various tolerances for dimensional and force parameters. The welding electrode tip monitoring device can generate a signal indicative of whether obtained data are within or outside the tolerance thresholds.

### BRIEF DESCRIPTION OF THE DRAWING

FIG. 1 is a perspective view of a welding electrode tip monitoring device of the instant invention showing welding tips disposed in a position to read geometry data;

FIG. 2 is a part exposed perspective of a welding electrode tip monitoring device of the instant invention showing welding tips disposed in a position to read force data;

FIG. 3 is a section end view taken through line 3-3 of FIG. 1; and

FIG. 4 is a section end view taken through line 4-4 of FIG. 2.

FIG. 5 is another perspective view of a welding electrode tip monitoring device of the instant invention;

FIG. 6 is a top view of the invention;

FIG. 7 is an end view of the invention; and

FIG. 8 is a side view of the invention.

### DETAILED DESCRIPTION OF THE PREFERRED EMBODIMENT

Referring now to the drawings, the welding electrode tip monitoring device of the present invention is generally designated by the numeral 10. The welding electrode tip monitoring device 10 can monitor welding electrode tips 12 while attached to a robotic welder which is generally designated here by letter R. The welding electrode tip monitoring device 10 can preferably be automatically employed as part of a robotic step with the robotic welder R.

The welding electrode tip monitoring device 10 can include a “U” shaped housing 14 having opposing housing portions 16 and 18 and transverse connecting portion 20. Housing portion 16 has a face 22 which opposes face 24 of housing portion 18. Housing portion 16 includes a vision CCD camera with lens 26 which is operably disposed through face 22. Housing portion 18 is operably equipped with and light panel 28 which is operably disposed on face 24 and serves a back light for tips 12 when being viewed by camera 26.

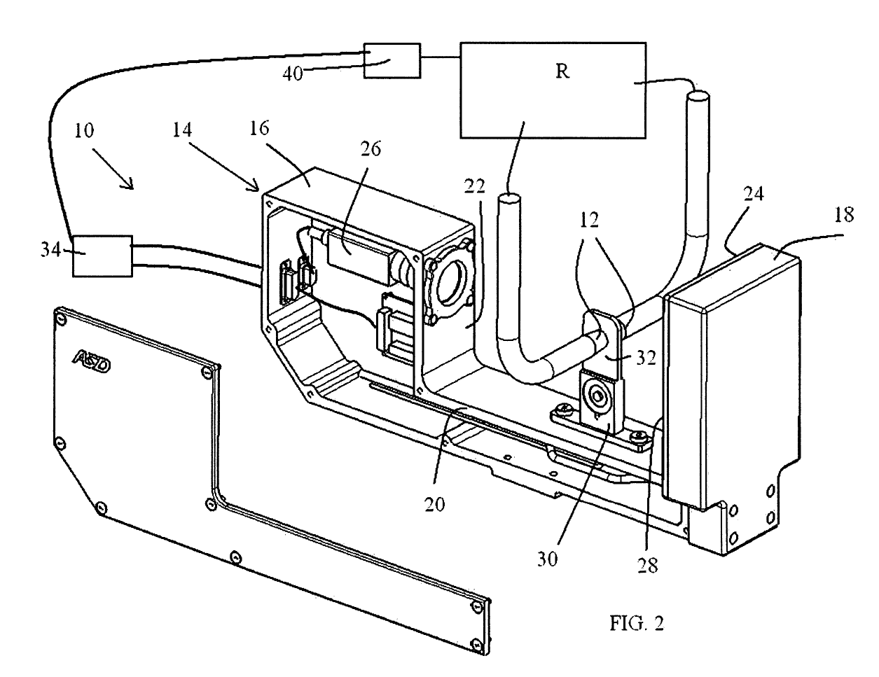

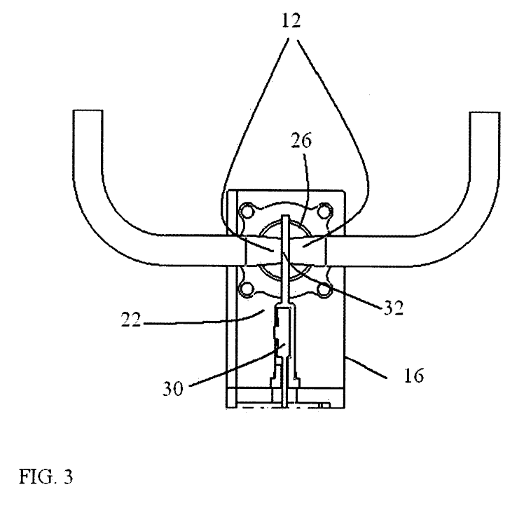

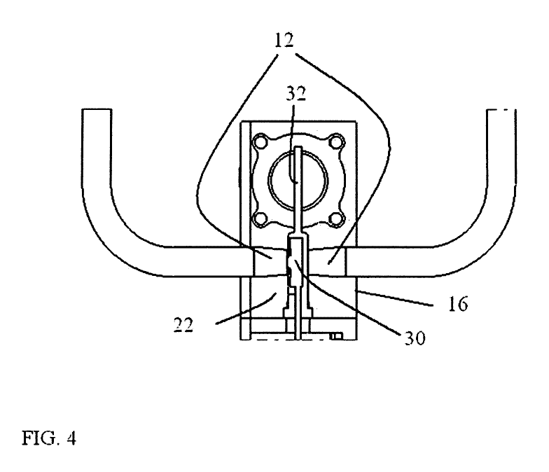

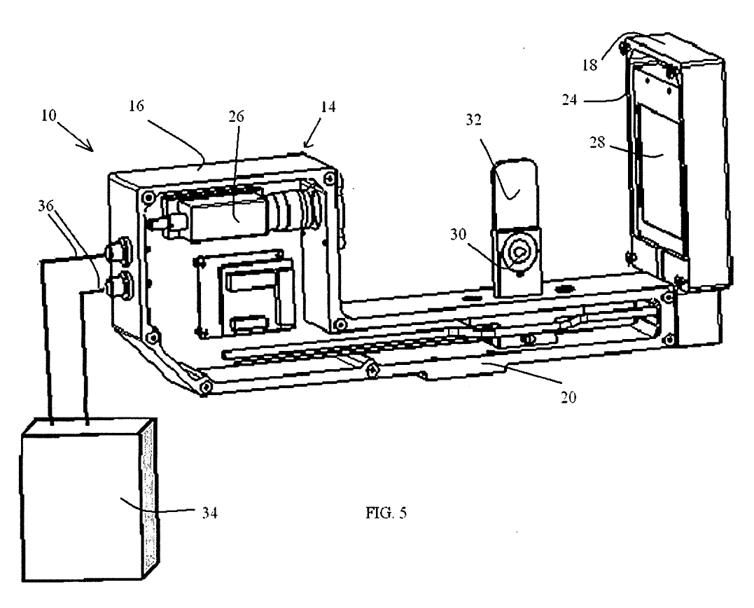

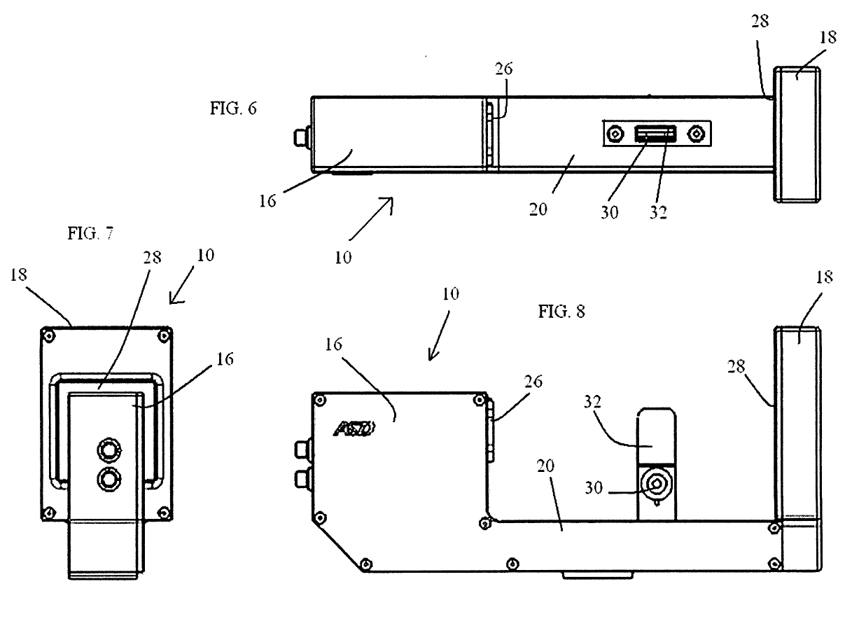

A load cell sensor 30 and electrode tip clamp plate 32 are operably disposed in and extend through transverse housing portion 20. The electrode tip clamp plate 32 extends sufficiently into a field of view of the camera 26 as depicted FIGS. 2 and 4 so that the camera 26 can obtain geometric data of the tips 12 when clamping plate 32. The load cell sensor 30 provides an adjacent location to obtain force data as a function of voltage pertaining to the tips 12.

A controller 34 is provided which is operably connected to the load cell sensor 30 and electrode tip clamp plate 32 and camera 26 and light panel 28 by way of electrical interfaces and cables 36. The controller 34 is operatively connected to the robotic welder R. The device 10 generates characteristic data of the welding electrode tips 12 without having to remove the tips 12 from the robotic welder R. Thus, the characteristic data can be obtained as part of an operation of the robotic welder R.

A process controller associated with the robotic welder R can receive the characteristic data and determine the need for changing the welding electrode tips 12 and or adjust an operation of the robotic welder R to affect weld characteristics. The welding electrode tip monitoring device 10 can as part of automatic operation measure dimensions of resistance weld tips, upper tip minimum contact diameter, lower tip minimum contact diameter, and center line misalignment of upper and lower tips through the camera 26, light 28 and interpretive software associated with the process controller 40. The welding electrode tip monitoring device 10 can preferably automatically measure robotic welder R clamp force through clamping on the sensor 30 and interpretive software.

The interpretive software residing on process controller 40 can preferably have a user defined tolerance threshold software associated therewith to specify various tolerances for dimensional and force parameters. The welding electrode tip monitoring device 10 can generate a signal indicative of whether obtained data are within or outside the tolerance thresholds. The welding electrode tip monitoring device 10 can have a user settable tolerance threshold software to specify the various tolerances for dimensional and force parameters.

The instant invention provides means of measuring critical features such as contact diameters, misalignment and force of resistance welding electrode tips 12 while still attached to the robotic welder R. This allows for in-process inspection, providing data for process control to maintain weld quality.

The welding electrode tip monitoring device 10 can be part of the robotic welder R and/or a work cell which contains the robotic welder R and within range of motion of the robotic welder R.

The welding electrode tip monitoring device 10 can output a digital signal when actual inspected values are outside the tolerance thresholds. The welding electrode tip monitoring device 10 can also send inspected actual values via digital interface using RS-232 serial or Ethernet communications. Method of Operation:

The welding electrode tip monitoring device 10 can be located in the robotic welding work cell, as the robotic welder R requires continuous monitoring of the critical features stated above to maintain weld quality. The welding electrode tip monitoring device 10 will enable the welding work cell to self monitor these features at predetermined cycles i.e. every 100, 200 or 500 welds, or whatever the process requires and communicate with the process control system to either re-dress or replace the tips.

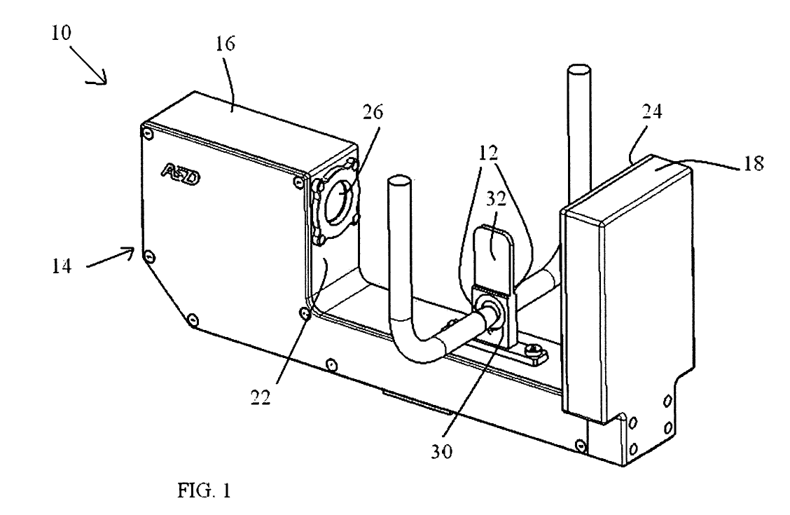

When the process controller instructs the robot welder to inspect the tips 12, the robot will position the tip inside the “U” shaped housing 14 of the welding electrode tip monitoring device 10. (See FIG. 4 Drawing). As seen in FIG. 2, the welding electrode tip monitoring device 10 will trigger the camera 26 and inspect the dimensional features as described above for the tips 12. The robot welder R will then move to the tips 12 to the position as seen in FIG. 1 and clamp on the load cell sensor 30. After 5 seconds, the maximum force inspected is obtained and recorded.

The obtained data is compared to the tolerance threshold values and a signal is returned to the work cell process controller 40 as to the condition of the tip features. The work cell process controller 40 can be programmed to return to welding, re-dress the tips, replace the tips or signal the cylinder force requires maintenance.

While the present invention is presented in the aforementioned embodiment, it is not intended to be limiting of the invention. Those skilled in the art will readily appreciate that variations, modification, and derivations of the invention and the claims appended hereto should be afforded the same.

What is claimed is:

1. A method of measuring a resistance spot welding electrode tip connected to a robotic welder,: which includes the steps of:
(a) operatively associating a welding electrode tip monitoring device with the robotic welder for monitoring said welding electrode tip while attached to the robotic welder such that said welding electrode tip monitoring device is automatically employed as part of a robotic step by said robotic welder, and
(b) generating characteristic data of said welding electrode tip during said operation of said robotic device through said welding electrode tip monitoring device.

2. The method of claim 1, which further includes said step of using said characteristic data to determine a need for changing said welding electrode tip.

3. The method of claim 1, which further includes using said characteristic data to adjust an operation of said robotic welder to affect weld characteristics.

4. The method of claim 1, which further includes employing a process controller to receive said characteristic data and control said robotic welder as a function of said received characteristic data.

5. The method of claim 1, which is further characterized such that said welding electrode tip monitoring device is automatically employed at predetermined intervals.

6. The method of claim 4, wherein said process controller performs one of re-dressing or replacing said welding tip as a function of said characteristic data.

7. The method of claim 1, wherein said welding electrode tip monitoring device includes a tip geometry obtaining mechanism and tip force obtaining mechanism.

8. A device for measuring a resistance spot welding electrode tip connected to a robotic welder, which includes:
a welding electrode tip monitoring device for monitoring a welding electrode tip, said welding electrode tip monitoring device communicatively connected to a robotic welder which is equipped with electrode welding tips, wherein said welding electrode tip monitoring device is employed automatically as part of a robotic step with said robotic welder and is equipped with means for generating characteristic data of said welding electrode tips without having to remove said welding tips from said robotic welder.

9. The device of claim 8, which includes a process controller to receive said characteristic data and determine a need for changing said welding electrode tips.

10. The device of claim 8, which includes a process controller to receive said characteristic data and adjust an operation of said robotic welder to affect weld characteristics as a function of said characteristic data.

11. The device of claim 10, wherein said welding electrode tip monitoring device includes means operably associated with said process controller for obtaining tip geometry and includes means operably associated with said process controller for obtaining tip force.

12. The device of claim 11, wherein said welding electrode tip monitoring device measures dimensions of said welding electrode tips, including upper tip minimum contact diameter, lower tip minimum contact diameter, and center line misalignment of said welding electrode tips.

13. The device of claim 11, wherein said welding electrode tip monitoring device measures robotic clamping force.

14. The device of claim 11, wherein said obtaining tip geometry means includes an image capturing device and an opposing back light.

15. The device of claim 14, wherein said obtaining tip geometry means includes and a tip clamping plate.

16. The device of claim 11, wherein said obtaining tip force includes and a load cell sensor.

17. The device of claim 11, wherein said welding electrode tip monitoring device is operatively associated a process controller having a user defined tolerance threshold software associated therewith which specifies tolerances for dimensional and force parameters for said electrode welding tips.

18. The device of claim 17, wherein said welding electrode tip monitoring device can generate a signal indicative of whether obtained data are within or outside said tolerance thresholds.

19. The device of claim 11, wherein said tip force obtaining means are proximate said tip geometry obtaining means to permit characteristic data to be readily obtained.

20. The device of claim 10, wherein said process controller controls said robotic welder to inspect said electrode welding tips by positioning said tips inside a path viewed by said tip geometry obtaining means.

21. The device of claim 20, wherein said tip geometry obtaining means includes an image acquiring device.

22. The device of claim 10, wherein said force capturing means includes a load cell sensor which obtains force of said tips at a predetermined time.

23. The device of claim 10, wherein said welding electrode tip monitoring device compares said data to tolerance threshold values and returns a signal to said process controller as to condition of said tip features.

24. The device of claim 10, wherein said process controller is programmed to one of returning to welding, re-dressing said tips, replacing said tips and signaling that sensor requires maintenance.
